(19) United States
(12) Patent Application Publication
(10) Pub. No.: US 2003/0064351 A1
(43) Pub. Date: Apr. 3, 2003

(54) Educational method

(76) Inventor: William E. Hillenbrand, Terrace Park, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 10/228,846

(22) Filed: Aug. 27, 2002

Related U.S. Application Data
(60) Provisional application No. 60/325,867, filed on Sep. 28, 2001.

(51) Int. Cl. G09B 19/00

(52) U.S. Cl. 434/219

(57) ABSTRACT

An educational method that integrates technology with the creative process to guide students in creating their own stories and art collected in a thematic anthology, produced as a digital book accessible from a CD-ROM or other memory device. Over a period of several months, the present invention guides participants (students, teachers, etc.) through the creative process, using a selected theme integrated with curriculum, a visiting author, and the creative process including brainstorming, research, drafts and revision, to develop a literary work accompanied by the artwork of those students contributing to the literary work. The compilations are organized into a digital book anthology, and may be saved on a memory device such as a magnetic disk or CD. The invention fits the needs of productive educational environments by creating outcome-based lessons that help students develop skills in critical thinking, writing, visual expression, communication and potentially other subjects such as science and geography.

### CROSS-REFERENCE TO RELATED APPLICATION

This application claims the benefit of U.S. Provisional Application Serial No. 60/325,867, entitled, “EDUCATIONAL METHOD”, filed on Sep. 28, 2001.

### BACKGROUND

1. Field of the Invention

The present invention relates to methods to stimulate educational development, and more particularly, is directed to educational methods that integrate retrospective experiences with constructive prospective application in a manner that reinforces the retrospective experiences of the student on a tangible medium for future reference.

2. Background of the Invention

The educational experience includes many facets, depending in large part upon the developmental capabilities of the student and the environment created by the teacher. While it is well known in the area of education to invite third parties to present material to students derived from the professional experiences of the third party. These methods, however, have generally provided no or few avenues through which the students may build upon the knowledge imparted or apply such knowledge.

It is also well known in educational settings to videotape or provide a video feed such that students at remote locations may partake in the educational experience. While these videotapes provide a tangible form through which the lecture or presentation of the third party may be reproduced or viewed again, there currently is a need for an educational method in which prospective projects derived from or supplemented by the intervention of the third party are captured and recorded for later retrieval. Such retrieval might include: downloading the captured data over the Internet, uploading the information from a tangible storage medium such as a hard drive, CD-ROM, or other memory disk, as well as transmitting data via a closed network link between personal computers or between personal computers and computer servers.

### SUMMARY

The invention provides an exciting literacy training tool that integrates technology with the creative process to guide students in creating their own stories and art collected in a thematic anthology, produced as a digital book accessible from a CD-ROM or other memory device. Over a period of several months, the invention guides participants (students, teachers, etc.) through the creative process, using a selected theme integrated with curriculum, a visiting author, and the creative process including brainstorming, researching, drafting and revising to develop a literary work accompanied by artwork of those students contributing to the literary work. The compilations are then captured electronically and organized into a digital book anthology, accessible by at least the contributors to the anthology. The present invention fits the needs of productive educational environments by creating outcome-based lessons that help students develop skills in critical thinking, writing, visual expression, communication and potentially other subjects such as science and geography.

The invention provides a unique opportunity for schools or other groups to use the creative process to develop communication skills. More than just another compilation of student works, the invention guides the creative process over several months to stimulate individual expression. An author-in-residence is an integral part of the program, bringing a published author of children's books to the classroom to inspire both students and teachers. In the end, a professional-looking e-book is produced on CD and distributed to every student or family as a lasting example of that year's learning.

The invention helps children of all ages create, through words and art, an expression that is uniquely and totally their own—and to celebrate the diversity found in individual expression.

It is, therefore, a first aspect of the invention to provide an educational method comprising the steps of: presenting a professional guest to a group of students; conducting at least one workshop with the group of students by the professional guest, the subject of the workshop being directly related to at least one of the professional guest's area of profession and the professional guest's area of expertise; generating a lesson-plan associated with the workshop for the group of students, the lesson-plan encouraging the students to create a work in a tangible medium; collecting works from the students; converting the collected works into a digital format; and, storing the collected and digital works into a digital compilation.

It is a second aspect of the invention to provide an educational method comprising the steps of: lecturing the students by an artist; selecting a topic related to the artist's work; producing works pertaining to the topic; compiling the works produced by the students; and, storing digital forms of the works onto a storage medium.

In a more detailed embodiment, the professional guest is a published author and the workshop is related to writing skills. In a further detailed embodiment the works include visual and written elements. In yet a further detailed embodiment, the method is conducted with multiple groups of students, such as different grade levels in a school. In yet a further detailed embodiment, each group is given a respective lesson-plan and wherein all the lesson-plans are centered about a common theme.

In an alternate detailed embodiment, the digital compilation resides on a CD, on a Web-Page, or on some magnetic memory disk.

In another alternate detailed embodiment, the digital compilation includes an advertisement and the method includes the step of obtaining at least partial sponsorship for the digital compilation in exchange for advertising space on the digital compilation.

In another alternate detailed embodiment the digital compilation includes biographical information on the guest. In a further detail, the digital compilation includes a work provided by the guest.

In another alternate detailed embodiment, the group of students may be grade school, high school and/or college students, a community group, a church group, a professional group, and the like.

### BRIEF DESCRIPTION OF THE DRAWINGS

FIG. 1 is an exemplary illustration of a front page in an anthology product produced in accordance with the present invention.

FIG. 2 is an exemplary illustration of a student work produced in accordance with the present invention.

FIG. 3 is an exemplary set of submission instructions in accordance with the present invention.

FIG. 4 is an exemplary illustration of a page acknowledging patrons of the anthology product produced in accordance with the present invention.

FIG. 5 is an exemplary illustration of a page in an anthology product produced in accordance with the present invention.

### DETAILED DESCRIPTION

Writing is a difficult skill to learn—even harder to teach. While most teachers are expected to teach writing, few have actually had a good course in writing. An author-in-residence helps teachers explore new ways to teach communication through words and art.

The invention is intended as an on-going, cumulative process. Each year reinforces the previously learned skills and introduces or refines other literacy building blocks such as organization, punctuation and paragraphing.

The invention will typically focus on a single theme, usually one presented by the author-in-residence. The theme may also be the product of dialog between the author-in-residence and the faculty and students. This theme approach is used across all grade levels, with each grade developing the theme in a manner that is appropriate to that grade level and consistent with outcome goals established for that grade level. For example, a kindergartner may use a simple art technique like crayons to draw pictures and may work with the teacher or parent volunteer to create a simple story. A sixth grader, on the other hand, may use more advanced techniques, like etchings and haiku, which are part of their normal curriculum.

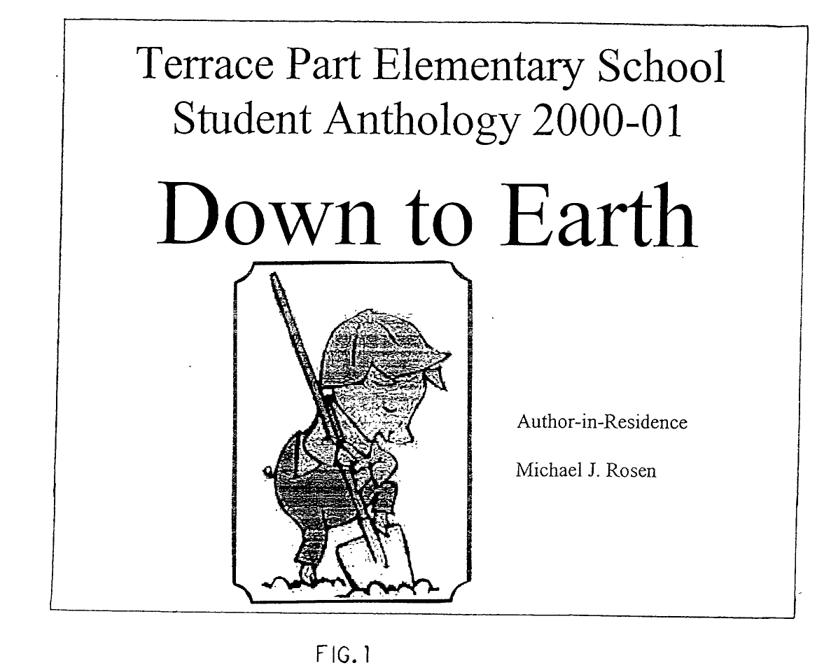

In the first exemplary embodiment, the project theme is Down to Earth, the title of a book by Michael J. Rosen, who services as the invention's author-in-residence (See FIG. 1). Each class reads the book and discusses its content. Students may be asked to “brainstorm” about something that grows, writing freely any ideas that come to them. Students can connect with, “Did your Mom, Grandmother, etc. make a food out of something grown?” or “Do you have a favorite tree?” or “Does the smell of a flower or grass remind you of anything?” These questions spark ideas and lead students to create something that is original and meaningful to them, not just the simplest and easiest way to complete the assignment. By stimulating this creativity and individual response, over the school year, the students also develop self-confidence and self-identity.

The invention also creates an opportunity for integrated learning; it is not restricted to writing and art classes. Science, math, geography, history, music, computers and other subjects can explore the theme as well, again stimulating the students' thinking and creativity.

An exemplary outline incorporating the “Down to Earth” theme may be divided into four subsets including language arts, science, geography and social studies. These subsets may further be divided into particular areas of interest. For example, the language arts subset may be comprised of: books revealing foods related to cultures and customs; exposure to other languages (spoken and in print); art from other cultures; and, researching related topics.

Science, for example, may be comprised of: studying botany by looking at plant types and diversity, seasonal and life cycles, and plant anatomy; studying chemistry by looking at photosynthesis, sexual and asexual reproduction, cell permeability along with the chemicals naturally produced by plants and animals, as well as combustion and its byproducts; studying zoology by identifying animals and family traits; and, studying living science in general by seeing how plants and animals are classified using kingdom, phylum, class, order, family, genus and species.

Geography may, for example, be comprised of: studying the physical features of the earth's crust along with why the poles of the earth are cooler than the equator region; and, studying anthropology to learn about the evolution of cultures and human beings as intertwined with the geographical features. Social studies may also be comprised of, for example: studying current events both domestic and abroad; studying the impact of various economies on the world economy; and, studying domestic history as well as foreign history.

After themes have been chosen, the author-in-residence provides in-service workshops for the faculty directed at the creative process and project goals and outcomes. The faculty learns new tools to use in teaching writing, while concurrently developing a heightened knowledge of how to integrate text and pictures to create compilations. The in-service workshops cover idea gathering, research, idea manipulation, artistic approaches and other relevant subjects.

The faculty then develop their own lesson plans based on the information presented. The author and a production company may partner with faculty to assure that the project goals are met.

The author-in-residence also meets with students to provide guidance and encouragement. The visits by the author generate a level of excitement that stimulates young minds and provides a role model like no other. It is envisioned that the author-in-residence visit with faculty and students at least once during the course of the project. However, each host should carefully consider the option that more visits may produce a better experience and educational outcomes for the students.

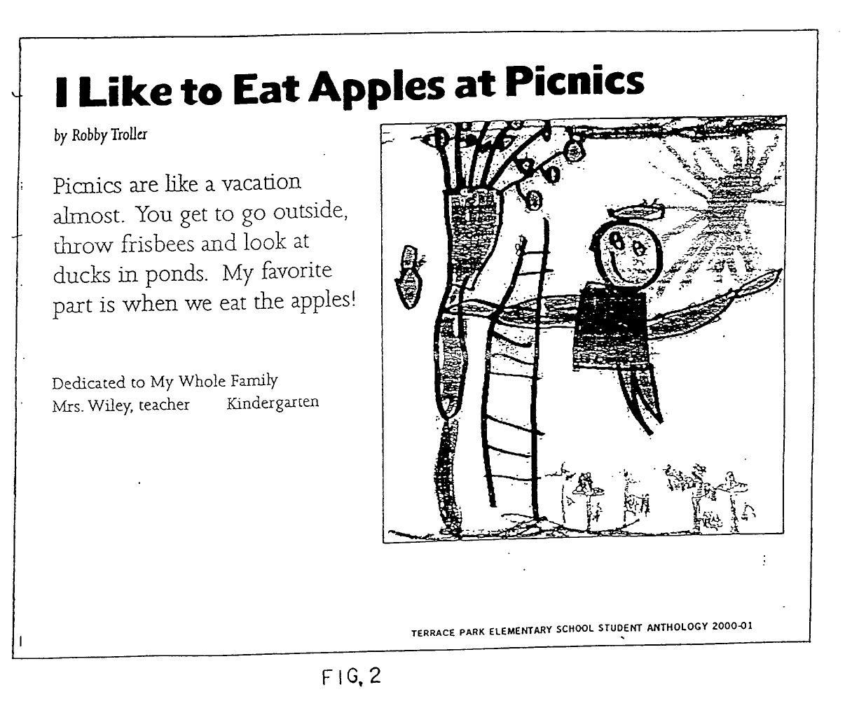

Through each stage of the process—brainstorming, researching, rough drafting, editing, adding artwork, etc.—students are given tools to mold their compilations into something which will be very gratifying. The collection of the students' work will result in an electronic anthology full of unique experiences and expressions that reflects the diversity of the student population. (See FIG. 2) By stimulating this creativity and individual response, over the course of the school year, the students develop self-confidence and self-identity.

A product of the invention, the electronic anthology, may be in the form of an e-book on CD. It can be printed to an individual's color printer or taken to a copy service for reproductions. The CD may be copyrighted, prohibiting the product of the invention from being reproduced in quantities in excess of 10 or through offset printing.

In the exemplary embodiment, the host school submits files that are consistent with certain specifications.

Text creation can be accomplished through several approaches. Teachers, staff members, parent volunteers, even children themselves, may be involved in the input of material. It is desired, however, that a final editor be responsible for assuring that all formatting is correct.

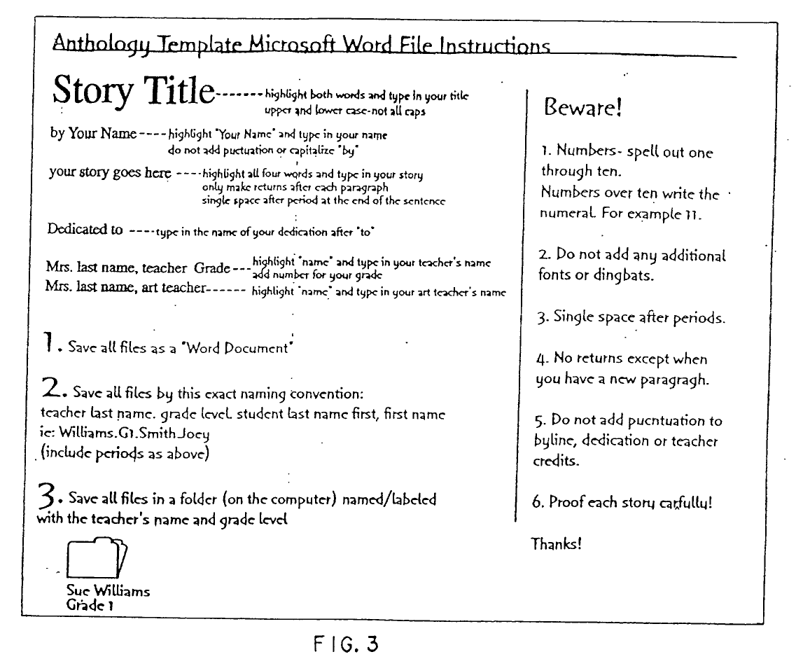

In the exemplary embodiment, text is submitted in Microsoft Word files produced according to a template provided by the invention (See FIG. 3). This assures that all headings, text, dedications and other types of formatting are consistent throughout the electronic anthology.

In the exemplary embodiment, the visual art should be no larger than 8 inches by 8 inches or proportional to a square and consistent in size per art technique. Digital photography, scanning or other method is utilized to transform any non-digital works into digital works.

Once the works are compiled, the compiled material is delivered to a production company. A final draft will be provided in approximately 6 to 8 weeks for review by the host school. The product CDs carrying the anthology in digital form will be delivered to the school in approximately 3 to 6 weeks after the final draft is approved.

Each page of the anthology may include a student work having:

A title

A byline

Student's story or poem (approx. 200 words)

A dedication (one line only, approx. 30 characters)

the student's teacher's name and grade level (See FIG. 3).

A folio line including the school name and date

Crucial to any child's education is parental involvement. It is believed that periodic communications with parents throughout the creative process may be important to the project's success.

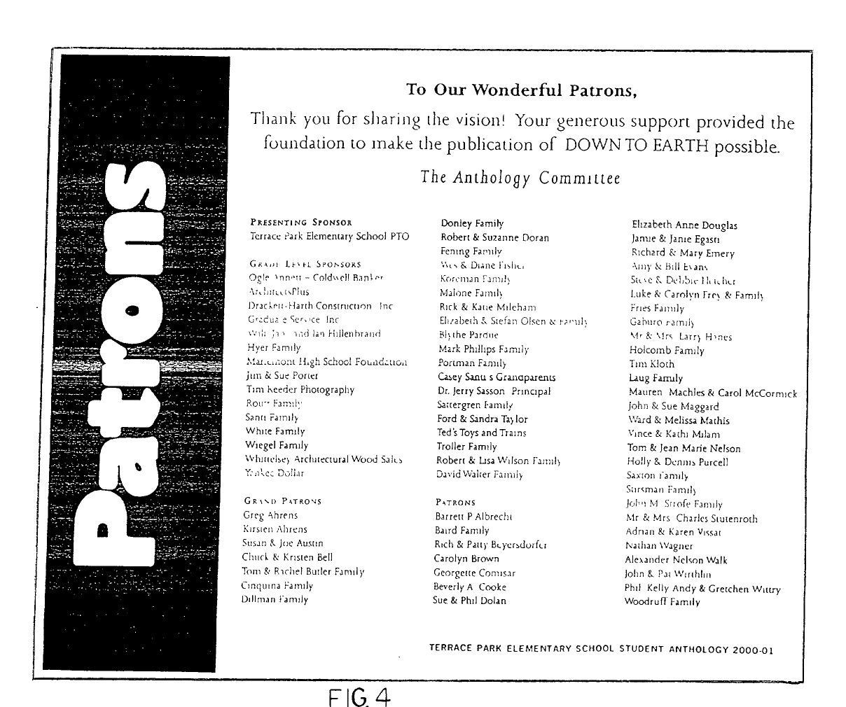

The invention provides the school with a series of advertising opportunities for sponsors (See FIG. 4). The invention also provides the school with a series of communication pieces to be used with sponsors and parents. Such communications include an introduction of the project and its goals, requests for sponsorships, updates on funding goals, invitation to a family night with the author-in-residence, and information on project status.

While costs can vary to a certain extent due to school size, the final price tag is usually more than most schools can afford out of an ordinary budget.

The invention recognizes the need for alternative funding and has incorporated an optional funding structure based on sponsors. The school may use one or all of the sponsorship levels to raise the money necessary for the project. While local companies are the most likely targets for sponsorship, other entities to consider include parents groups, foundations, national corporations, educational services and e-businesses. A single entity also may underwrite the entire project.

In the exemplary embodiment, the cost for an average school (population 350) is $10,000. The total can be raised through multiple sponsors, based in part on the following structure:

Presenting Sponsor—$2,250—Presenting sponsors are featured on a special page in the beginning of the anthology. This page can include a company logo, description of the organization and a hot link to a web site. (See FIG. 4) For an additional amount, presenting sponsors also might include an electronic catalog, a video or audio clip, an order form or additional advertising on the disk (space permitting).

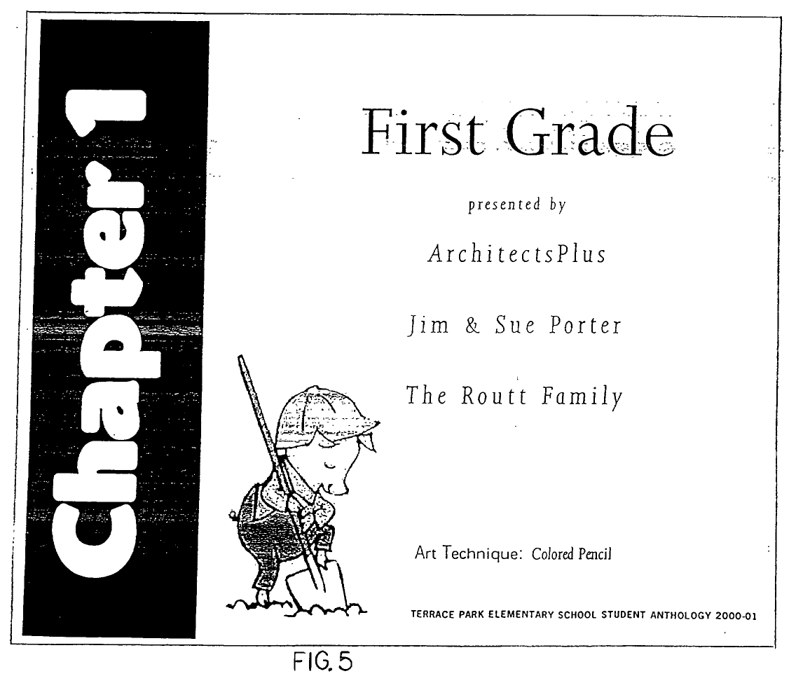

Chapter level Sponsors—$500 each (total of $3,500 for seven grades)—These sponsors receive recognition on the title page for the grade they sponsor. Logos may be used if provided in acceptable electronic format. (See FIG. 5)

Patron Support—$20 each (goal: total of $400 from 20 patrons)—These patrons receive a type-only mention on a page in the back section of the invention (See FIG. 4). Patrons could be parents, extended family members, small business and other community members.

Other alternative funding methods could include charging each student a material fee, ranging from the full cost of the project to a more nominal charge. The level of fee must be consistent with every student's ability to pay; no student should be left out because his or her family cannot afford the fee.

While the invention was originally designed to be used with an elementary school, grades K-6, the concept could be used with any grade levels. The basic concepts—using an author-in-residence, focusing on one or more themes, developing individual creative expressions—can be used with middle schools, high schools and even colleges as well.

The exemplary embodiment of the invention employs a nationally recognized published children's book author to help students and faculty learn more about the creative process. Most often, the author-in-residence is contracted to visit and is not a permanent employee of the school system.

The invention also might be used with community groups, perhaps to explore critical social issues. A local library, church or community council might sponsor the present invention, drawing from a wider range of ages and across school district borders.

Additionally, while the electronic anthology is distributed in the form of an e-book on a CD in the exemplary embodiment, it is within the scope of the invention to place the electronic anthology on another form of memory, such as on a server accessible over the Internet.

It is additionally within the scope and spirit of the present invention to provide a software template through which the works of the students may be compiled, saved and thereafter transmitted to the production company for final revisions and production of the final version of the anthology. While the exemplary embodiment discloses the production company producing CDs carrying the anthology thereon, it is also within the scope and spirit of the present invention that the production company establish a network link for transmission of the anthology in electronic form accessible by the faculty, students, parents and other authorized users.

It is also within the scope and spirit of the present invention for the production company (or some other entity) to provide compilation software, thereby enabling the school to produce an electronic form of the anthology that may be produced by the school itself. In an exemplary embodiment, the school would have access to CD burners or other types of hardware enabling reproduction of the anthology via a tangible form. It is also within the scope of the invention that the compilation software format the anthology to be viewed as a Web-page. In this manner, the school may utilize any existing website capability and enable access to the digital anthology through the site.

Following from the above description and invention summaries, it should be apparent to those of ordinary skill in the art that, while the methods herein described constitute exemplary embodiments of the present invention, it is to be understood that the inventions contained herein are not limited to these precise embodiments and that changes may be made to them without departing from the scope of the inventions as defined by the claims. Additionally, it is to be understood that the invention is defined by the claims and it not intended that any limitations or elements describing the exemplary embodiments set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. An educational method comprising the steps of:
presenting a professional guest to a group of students;
conducting at least one workshop with the group of students by the professional guest, the subject of the workshop being directly related to at least one of the professional guest's area of profession and the professional guest's area of expertise;
generating a lesson-plan associated with the workshop for the group of students, the lesson-plan encouraging the students to create a work in a tangible medium;
collecting works from the students;
converting the collected works into a digital format; and
storing the collected and digital works into a digital compilation.

2. The educational method of claim 1 wherein the professional guest is a published author and the workshop is related to writing skills.

3. The educational method of claim 2, wherein the works include visual and written elements.

4. The educational method of claim 3, wherein the method is conducted with multiple groups of students, such as different grade levels in a school.

5. The educational method of claim 4, wherein each group is given a respective lesson-plan and wherein all the lesson-plans are centered about a common theme.

6. The educational method of claim 1, wherein the digital compilation resides in a CD, on a Web-Page, or some other electronic memory device.

7. The educational method of claim 1, wherein the digital compilation includes an advertisement and the method includes the step of obtaining at least partial sponsorship for the digital compilation in exchange for advertising space on the digital compilation.

8. The educational method of claim 1, wherein the digital compilation includes biographical information on the guest.

9. The educational method of claim 8, wherein the digital compilation includes a work provided by the guest.

10. The educational method of claim 1, wherein the group of students are at least one of a grade school student group, a high school student group or a college student group, a community group, a church group and a professional group.

11. An educational method comprising the steps of:
lecturing the students by an artist;
selecting a topic related to the artist's work;
producing works pertaining to the topic;
compiling the works produced by the students; and
storing digital forms of the works onto a storage medium.

12. The method of claim 11, wherein the artist is an author.

13. The method of claim 12, wherein the author is an author of childrens literature.

14. The method of claim 11, further comprising the step of:
converting the works into digital form.

15. The method of claim 11, wherein the storage medium of the accessing step is one of a CD-ROM, a computer memory and an Internet server memory.

16. The method of claim 11, wherein the selecting step includes the steps of:
exchanging ideas between at least the artist and at least one faculty member;
choosing a topic from the ideas exchanged between the artist and the at least one faculty member; and
planning lessons by the at least one faculty member to correspond to the topic chosen.

17. The method of claim 11, wherein:
the selecting step includes the step of selecting a topic suggested by the artist;
the lecturing step includes the step of interaction between the artist and the students pertaining to the topic;
the producing step includes the step of allowing the students time to refine the works with the help of the artist;
the compiling step includes the step of organizing the works with the aid of software;
the storing step includes the step of saving the organized digital form of the works onto a local storage medium; and
the storing step includes the step of transmitting the digital form of the works over a network and storing the digital form onto a remote storage medium.

18. The method of claim 17, wherein the accessing step includes at least one of the following steps:
accessing the digital form of the works from the remote storage medium by an authorized party, such that the authorized party copies the digital form of the works onto a portable storage medium;
accessing the digital form of the works from the remote storage medium by an authorized party, such that the authorized party may view the digital works; and
accessing the digital form of the works from the remote storage medium by an authorized party, such that the authorized party accesses the digital form through the Internet.

19. The method of claim 11, further comprising the step of:
viewing the works after the storing step in a format discernable by a human being.
